(19) United States
(12) Patent Application Publication
(10) Pub. No.: US 2025/0145490 A1
(43) Pub. Date: May 8, 2025

(54) METHOD OF PRODUCING IRON(II) SULFATE HEPTAHYDRATE

(71) Applicant: AMATEQ HOLDING GMBH, Münster (DE)

(72) Inventor: Alexander KEHRMANN, Münster (DE)

(21) Appl. No.: 18/730,075

(22) PCT Filed: Jan. 21, 2022
(86) PCT No.: PCT/EP2022/051330

§ 371 Date: Jul. 18, 2024

(51) Int. Cl. C01G 49/14

(52) U.S. Cl. CPC C01G 49/14; C01P 2006/80

(57) ABSTRACT

In a method of producing iron(II) sulfate heptahydrate, a material containing iron oxide is subjected to a pre-processing treatment to adjust the particle size and/or the water content thereof. The pre-processed raw materials are then reacted with sulfuric acid, followed by a reduction treatment with elementary iron to produce iron(II) sulfate. The iron(II) sulfate may be purified and crystallized as iron(II) sulfate monohydrate prior to crystallization as iron (II) sulfate heptahydrate

### BACKGROUND OF THE INVENTION

The present invention relates to a method of producing iron(II) sulfate heptahydrate from a material containing iron oxide.

In the past iron(II) sulfate heptahydrate has been used as a chromate reducer for converting harmful chromium (VI) compounds into chromium (III) compounds, in cement, or for soil preparation. Further applications of iron(II) sulfate heptahydrate include its use as fertilizer, for phosphate precipitation in the purification of sewage water, for conditioning of sewage slurry, or as raw material for producing iron oxide pigments. Spent pickling solutions (pickling liquor) from the processing of steel have been used as a starting material for producing iron(II) sulfate heptahydrate and also for producing iron(II) sulfate monohydrate, which can be converted into iron(II) sulfate heptahydrate (see, for example, U.S. Pat. Nos. 4,222,997 and 4,382,916 A).

A spent pickling solution also serves as the starting material in the case of U.S. Pat. No. 5,417,955, which describes a method and device for treating a pickling liquor to produce hydrochloric acid and ferric sulfate. In the process of U.S. Pat. No. 5,417,955 iron(II) sulfate monohydrate, which is obtained as the initial product is subsequently oxidized in order to convert it into ferric sulfate.

More recent applications for iron(II) sulfate heptahydrate include its use as a battery material. CN 105293588 A describes a preparation method of battery grade iron(II) sulfate heptahydrate that starts out from iron(II) sulfate which is obtained as a by-product during the production of titanium dioxide. However, processes that are capable of utilizing other sources of iron for the production of high purity iron(II) sulfate heptahydrate in an economic manner still are lacking.

In view of the foregoing, it would be desirable and advantageous to provide new methods for producing high purity iron(II) sulfate heptahydrate. In order to achieve this objective the present inventors have sought to develop a method that utilizes materials containing iron oxide, and in particular ores comprising iron oxide, such as magnetite, as raw material.

### SOLUTION TO THE PROBLEM

The process of the present application utilizes materials containing iron oxide, such as the ore magnetite, as raw material. These materials are treated so as to obtain an aqueous slurry of iron oxide, followed by reaction with sulfuric acid (H₂SO₄) and reduction treatment with elementary iron to prepare iron(II) sulfate (FeSO₄), optional purification of the iron(II) sulfate and/or crystallization thereof as iron(II) sulfate monohydrate (FeSO₄.H₂O), and subsequent conversion of the iron(II) sulfate monohydrate into iron(II) sulfate heptahydrate (FeSO₄.7H₂O). While the iron(II) sulfate heptahydrate obtained in this manner generally already exhibits adequate purity to allow its use as a battery material, further purification measures thereof may also be carried out. The described process allows high-quality, durable and free flowing iron(II) sulfate heptahydrate to be obtained.

### SUMMARY OF THE INVENTION

The presently claimed invention provides a method of producing iron(II) sulfate heptahydrate from materials containing iron oxide, such as the ore magnetite.

The method includes the following steps, in the order as listed:
Step 1: Pre-processing a material containing iron oxide to adjust the particle size and/or the water content thereof,
Step 2: Reacting the pre-processed material with sulfuric acid, followed by reduction treatment with elementary iron to produce iron(II) sulfate,
Step 2a (optional): purifying the obtained iron(II) sulfate and/or crystallizing it as iron(II) sulfate monohydrate, and
Step 3: crystallizing the iron(II) sulfate as iron(II) sulfate heptahydrate.

Optionally, further purification may be carried out after the step of converting the iron(II) sulfate monohydrate into iron(II) sulfate heptahydrate.

### DETAILED DESCRIPTION OF PREFERRED EMBODIMENTS

The main steps of the claimed invention will be described in greater detail in the following.
(2) Pre-processing a material containing iron oxide to adjust the particle size and/or the water content thereof.

The first step of the process of the invention is aimed at converting the raw materials into a state that simplifies their further processing. This pre-processing typically includes adjustment of the particle size and/or the water content of the raw materials.

The raw materials that are employed in the process of the invention typically are ores comprising iron oxide, such as the ore magnetite, or materials that are generated during the processing of ores comprising iron oxide.

The raw materials typically will be in the form of solids or liquid-solid mixtures. In the case of raw materials that take the form of liquid-solid mixtures, the raw material may be subjected to solid-liquid separation to remove the liquids and recover the iron oxide-containing solids. Any method commonly employed in the art, such as a filtration method employing a belt filter or a drum filter, may be used to effect the separation.

In order to simplify the further processing thereof, the solid material, i.e. a solid raw material or the solids fraction obtained from a raw material in the form of a liquid-solid mixture, may be subjected to comminution so as to reduce the particle size thereof and to make the material more homogeneous. Any commonly known means for reducing particle sizes, e.g. crushing, grinding, cutting or vibrating, may be employed in this step, and the solid portion of the material preferably exhibits a particle size that allows it to pass through a mesh having openings the size of 50 mm or less, preferably 25 mm or less and more preferably 10 mm or less. The comminuted material may be washed with water in order to remove soluble impurities.

The comminuted material typically is mixed with water so as to prepare a slurry and to thereby improve the handling of the material. However, it may also be passed on to the next step as is.

If water is added to the comminuted material prior to passing it on to the next step, the amount of water being added is chosen so that the obtained liquid-solid mixture exhibits sufficient fluidity to allow for easy handling and conveyance thereof. From the standpoint of process economy, the solids content in the obtained liquid-solid mixture preferably will lie in the range of from 50 to 80% by weight, more preferably in the range of from 55 to 75% by weight and most preferably in the range of from 60 to 70% by weight.
(2) Reacting the Pre-Processed Material with Sulfuric Acid, Followed by Reduction Treatment with Elementary Iron to Produce Iron(II) Sulfate.

In this step of the process, the pre-processed raw materials are reacted with sulfuric acid to yield iron sulfate. To this end, the pre-processed raw materials are contacted with sulfuric acid in a reactor vessel to produce iron sulfate.

Any reactor vessel, that is commonly employed in the art for this type of transformation can be employed in the process of the present invention. Such reactor vessels typically include means for providing agitation or static mixing and means for heating and cooling.

The acid content of the sulfuric acid that is employed for the reaction typically will be at least 60% by weight, with an acid content of greater than 78% by weight being preferred. The ratio of the pre-processed raw materials comprising iron oxide to sulfuric acid being fed to the reactor typically is chosen so that the molar ratio of iron to sulfuric acid lies between 1.0/0.9 and 1.0/1.5, preferably between 1.0/1.0 and 1.0/1.3, more preferably between 1.0/1.0 and 1.0/1.2 and even more preferably between 1.0/1.0 and 1.0/1.1.

The temperature in the reactor vessel is controlled through intervention of a heat exchanger and typically lies in the range of from 50° C. to 100° C., preferably in the range of from 70° C. to 90° C., and most preferably in the range of from 80° C. to 90° C. The mean retention time of the reactants in the reactor vessel is determined on the basis of the iron content of the pre-processed raw materials and the concentration of the sulfuric acid and generally lies in the range of from 2 to 12 hours. Reaction monitoring can be used to suitably adjust the retention time. Once a sufficient proportion of the iron oxide, e.g. 70% or more thereof, preferably 80% or more thereof, and even more preferably 90% or more thereof, has reacted, the reaction mixture is subjected to solid-liquid separation to remove unreacted solids. Any method commonly employed in the art, such as a filtration method employing a belt filter or a drum filter, may be used to effect the separation. Water may be added to the reaction mixture prior to carrying out solid-liquid separation and the temperature may be controlled by means of heat exchange in order to ensure complete dissolution of the iron sulfate and/or to avoid premature precipitation thereof.

Since the pre-processed raw materials generally will comprise iron that exists in a divalent oxidation state, as well as iron that exists in a trivalent oxidation state, the immediate product of the reaction with sulfuric acid will comprise iron(II) sulfate, as well as iron(III) sulfate. In view thereof, reduction treatment with elementary iron for converting iron(III) sulfate into iron(II) sulfate is carried out following the reaction with sulfuric acid. The elementary iron that t is employed for this purpose may take the form of iron powder or iron scraps.

The conversion of iron that exists in a trivalent oxidation state into iron exhibiting a divalent oxidation state represents is a transformation that is well-known in the art and which can be realized by known procedures. In this transformation, iron(II) sulfate is generated from iron(III) sulfate by the reaction of iron(III) sulfate with elementary iron according to the following equation: Fe₂(SO₄)₃+Fe→3 FeSO₄.

The reaction mixture may be subjected to filtration after the reduction reaction in order to remove any remaining solids. Any method commonly employed in the art may be used to carry out this operation.
(2a) Optional Step of Purifying the Obtained Iron(II) sulfate and/or Crystallizing it as iron(II) sulfate monohydrate.

Depending on the raw material employed, the liquid fraction obtained in Step 2 may contain impurities that are difficult to remove at a later stage. In view thereof, the liquid containing the iron(II) sulfate may be subjected to further purification prior to the further processing thereof.

Different methods of removal may be suitable for different impurities. In view thereof, the process typically will comprise a combination of one or more purification measures, such as, for example, filtration, centrifugation, ion exchange, solvent extraction and electrochemical purification.

Typical filtration measures are ones employing activated charcoal or coke. These can be effective for removing heavy metals and organic impurities. Electrochemical purification measures can be used to remove impurities through reductive deposition. These can be effective for removing metal ions having a reduction potential that is higher than that of iron (II). Ion exchange and solvent extraction methods can be tailored for the removal of specific impurities, such as rare earth elements, and thus are particularly suited for adapting the process to different types of raw materials. The aforementioned purification measures allow the most pertinent impurities, such as heavy metals, transition metals and rare earth metals to be removed from the solution.

In addition to or instead the purification measures described above, the iron(II) sulfate may be crystallized as iron(II) sulfate monohydrate. In order to do so, the (purified) liquid containing the iron(II) sulfate is transferred to a precipitating reactor. Prior to, during the course thereof or after this transfer the concentration and temperature of the solution are adjusted so as to provide suitable conditions for the crystallization iron(II) sulfate monohydrate. This adjustment can include one or more of the following measures: adding sulfuric acid, adding or removing water, e.g. by evaporation, and adjustment of the temperature, e.g. through the use of heat exchangers. After the adjustment the concentration of sulfuric acid will be at least 40% by weight, more preferably at least 50% by weight, and even more preferably will lie in the range of from 55 to 65% by weight. The temperature will lie in the range of from 50° C. to 100° C., preferably in the range of from 70° C. to 90° C., and most preferably in the range of from 80° C. to 90° C.

The mean retention time of the solution of iron(II) sulfate in the precipitating reactor generally lies in the range of from 1 to 12 hours, and most commonly in the range of from 3 to 5 hours.

Concentration monitoring can be used for deciding when to end this stage of the process. At such a point, the mixture comprising crystallized iron(II) sulfate monohydrate is subjected to filtration, preferably pressure filtration to isolate the iron(II) sulfate monohydrate. Commonly employed means of filtration include a belt filter and a drum filter. The mother liquor filtrate can be recycled back into the reactor in order to improve the overall efficiency of the process. To further increase its purity, the iron(II) sulfate monohydrate may be washed after the filtration procedure, e.g. with water, dilute sulfuric acid or steam. From the standpoint of avoiding loss of iron(II) sulfate monohydrate, washing with sulfuric acid is preferable.

Further drying of the obtained iron(II) sulfate monohydrate may take place before it is fed to a crystallization reactor for conversion into iron(II) sulfate heptahydrate. Such a drying operation may employ any means that is commonly known in the art, e.g. centrifugation or subjecting the iron(II) sulfate monohydrate to a stream of heated air.

The obtained iron(II) sulfate monohydrate generally exhibits a high degree of purity of 90% and higher. If desired, further purification, e.g. by recrystallization, may be carried out at this stage.

### (3) Step of Crystallizing the iron(II) sulfate as iron(II) sulfate heptahydrate

In the final step of the process the iron(II) sulfate is crystallized as iron(II) sulfate heptahydrate. The exact conditions for this step will vary depending on whether or not the iron(II) sulfate already was crystallized as iron(II) sulfate monohydrate

The conversion of the iron(II) sulfate monohydrate into iron(II) sulfate heptahydrate can be realized by known means, and typically is achieved by mixing the iron(II) sulfate monohydrate with excess water in a crystallization reactor so as to allow the iron(II) sulfate monohydrate to dissolve and iron(II) sulfate heptahydrate to be generated by the addition of water to the dissolved iron (II) sulfate according to the following equation: FeSO₄+7H₂O→FeSO₄.7H₂O.

From the standpoint of maximizing the yield of the iron(II) sulfate heptahydrate, the weight ratio of iron(II) sulfate monohydrate to water preferable lies in the range of from 1.00 to 1.65, more preferable in the range of from 1.18 to 1.57, and even more preferable in the range of from 1.35 to 1.57, and most preferable in the range of from 1.45 to 1.55.

The temperature in the crystallization reactor and the retention time can be adjusted to optimize the crystallization process. In practice, the retention time generally will lie between four and eighteen hours and the temperature is kept between 10° C. and 50° C., preferably in the range of from 10° C. to 45° C., more preferably in the range of from 15° C. to 40° C., and most preferably in the range of from 20° C. to 35° C. This allows iron(II) sulfate heptahydrate to be formed as a crystallized product of high purity which can readily be separated from excess water and dissolved impurities. In order to support the dissolution of the iron(II) sulfate monohydrate, the temperature may initially be raised to a higher level.

The separation of the crystallized iron(II) sulfate heptahydrate from excess water and dissolved impurities can be realized by means commonly known in in the art, such as filtration, preferably pressure filtration. Commonly employed means of filtration include a belt filter and a drum filter. Another approach for separating the crystallized iron(II) sulfate heptahydrate involves centrifugation. The separated liquid can be recycled back into the reactor in order to improve the overall efficiency of the process. To further increase its purity, the iron(II) sulfate heptahydrate may be washed after the separation procedure, e.g. with water.

Further drying of the obtained iron(II) sulfate heptahydrate may also take place. Such a drying operation may employ any means that is commonly known in in the art, e.g. subjecting the iron(II) sulfate heptahydrate to a stream of heated air or air drying at ambient or elevated temperature.

The obtained iron(II) sulfate heptahydrate generally exhibits a very high degree of purity, (95% or higher, and even 99% or higher).

A crystallization reactor may also be employed for preparing iron(II) sulfate heptahydrate in a case where the iron(II) sulfate was not already crystallized as iron(II) sulfate monohydrate. In such a case, the concentration of iron(II) sulfate in the liquid containing the iron(II) sulfate is adjusted so that the weight ratio of iron(II) sulfate in the mixture lies within the range of from 46 to 54% by mass, preferable within the range of from 48 to 54% by mass, and more preferable within the range of from 51 to 54% by mass, and most preferable within the range of from 53 to 54% by mass. This is done by adding water to or removing it from the liquid containing the iron(II) sulfate as needed. If water is added to the liquid containing the iron(II) sulfate, this can be done prior to or after charging into the crystallization reactor. If water needs to be removed from the liquid containing the iron(II) sulfate, this is done prior to charging into the crystallization reactor.

The removal of water from the liquid containing the iron(II) sulfate the solution can be achieved by fractionated distillation. This typically involves pre-heating the solution to a temperature of about 95° C. in a heat exchanger and then feeding the heated liquid to a distillation column for fractionation. Water vapor can be recovered for reuse from the upper part of the distillation column and a concentrated solution of iron(II) sulfate can be withdrawn from the lower part of the distillation column. Part of the withdrawn solution of iron(II) sulfate may also be returned to the distillation column in order to improve process efficiency.

The conditions for operating the crystallization reactor and recovering the iron(II) sulfate heptahydrate in a case where the iron(II) sulfate was not already crystallized as iron(II) sulfate monhydrate are the same as in the case where the iron(II) sulfate already was crystallized as iron(II) sulfate monohydrate.

1. A method of producing iron(II) sulfate heptahydrate, the method comprising the following steps, in the cited order:
Step 1: pre-processing a material containing iron oxide to adjust the particle size and/or the water content thereof, Step 2: reacting the pre-processed material with sulfuric acid, followed by reduction treatment with elementary iron to produce iron(II) sulfate, and
Step 3: crystallizing the iron(II) sulfate as iron(II) sulfate heptahydrate.

2. The method according to claim 1, wherein the material containing iron oxide comprises an ore or a material that is generated during the processing of an ore.

3. The method according to claim 2, wherein the ore is magnetite.

4. The method according to claim 1, wherein iron powder or iron scraps are used as reducing agent in Step 2.

5. The method according to claim 1, wherein the reaction with the sulfuric acid in Step 2 is carried out at a temperature of from 70° C. to 90° C.

6. The method according to claim 1, wherein the rection with the sulfuric acid is allowed to proceed for a period of from 2 to 12 hours.

7. The method according to claim 1, wherein, in Step 2, the sulfuric acid is used in such an amount that the molar ratio of iron to sulfuric acid lies in the range of from 1.0/0.9 to 1.0/1.5.

8. The method according to claim 1, wherein Step 2 comprises filtration of the reaction mixture prior to and/or after the reduction treatment with elementary iron.

9.-11. (canceled)

12. The method according to claim 1, further comprising:
a Step 3a of carrying out filtration or centrifugation to isolate the iron(II) sulfate heptahydrate and/or
a Step 3b of washing and/or drying the iron(II) sulfate heptahydrate after the Step 3 of crystallizing the iron(II) sulfate as iron(II) sulfate heptahydrate.

13. The method according to claim 1, wherein Step 3 comprises treatment in a crystallization reactor for a period of from four to eighteen hours at a temperature of from 30° C. to 45° C.

14. The method according to claim 1, wherein Step 3 comprises the preparation of an aqueous solution having a weight ratio of iron(II) sulfate of from 46 to 54% by mass.

15. The method of claim 1, further comprising Step 2a of purifying the obtained iron(II) sulfate and/or crystallizing the iron(II) sulfate as iron(II) sulfate monohydrate.

16. The method of claim 15, wherein the material containing iron oxide comprises an ore or a material that is generated during the processing of an ore, wherein the ore is magnetite.

17. The method of claim 15, wherein Step 2a comprises one or more procedures selected from filtration, centrifugation, ion exchange, solvent extraction and electrochemical purification.

18. The method of claim 15, wherein the reaction with the sulfuric acid in Step 2 is carried out at a temperature of from 70° C. to 90° C.

19. The method of claim 18, wherein the temperature is adjusted to lie in the range of from 70° C. to 90° when crystallizing iron(II) sulfate monohydrate in Step 2a.

20. The method of claim 15, wherein the concentration of the sulfuric acid is adjusted to be at least 50% of the combined total weight when crystallizing iron(II) sulfate monohydrate in Step 2a.

21. The method of claim 12, wherein Step 3 comprises treatment in a crystallization reactor for a period of from four to eighteen hours at a temperature of from 30° C. to 45° C.

22. The method of claim 12, wherein Step 3 comprises the preparation of an aqueous solution having a weight ratio of iron(II) sulfate of from 46 to 54% by mass.)

23. The method of claim 15, further comprising:
a Step 3a of carrying out filtration or centrifugation to isolate the iron(II) sulfate heptahydrate and/or
a Step 3b of washing and/or drying the iron(II) sulfate heptahydrate
after the Step 3 of crystallizing the iron(II) sulfate as iron(II) sulfate heptahydrate.
